(19) United States
(12) Patent Application Publication
(10) Pub. No.: US 2005/0009707 A1
(43) Pub. Date: Jan. 13, 2005

(54) APG granulates containing agrochemical active ingredients

(76) Inventors: Michael P. Pompeo, Mason, OH (US); Hans-Georg Mainx, Leichlingen (DE); Rainer Eskuchen, Langenfeld (DE); Melanie Roessing, Oberhausen (DE); Benoit Abribat, Saint Fargeau Ponthierry (FR)

Correspondence Address: COGNIS CORPORATION;PATENT DEPARTMENT, 300 BROOKSIDE AVENUE, AMBLER, PA, 19002, US

(21) Appl. No.: 10/860,175

(22) Filed: Jun. 3, 2004

Related U.S. Application Data
(60) Provisional application No. 60/484,596, filed on Jul. 2, 2003.

(51) Int. Cl. A01N 25/10

(52) U.S. Cl. 504/361

(57) ABSTRACT

Granulated solids containing at least (A) a compound of the general formula RO-[G]ₚ, in which R represents an alkyl and/or alkenyl radical with 4 to 22 carbon atoms, G represents a sugar radical with 5 or 6 carbon atoms, and p represents numbers from 1 to 10, and (B) water-soluble, nonionic, homopolymeric and/or copolymeric compounds, wherein the monomers are selected from compounds of the formula R¹R²C═CR³X, in which R¹, R², and R³ each independently represent a hydrogen atom or an aliphatic alkyl radical with 1 to 4 C atoms or an acryl radical possibly containing N or O atoms and X represents a group OR⁴, OCOH, OCOY, OCOR⁵, CONR⁶, CN, NR⁷₂, NH—CO—R⁸, wherein the radicals R⁴ to R⁸ independently represent a hydrogen atom or saturated or unsaturated, branched or unbranched aliphatic or aromatic organic radicals with 1 to 22 C atoms, and Y represents a cation, unsaturated dicarboxylic acids, preferably maleic acid or aspartic acid and derivatives thereof, isocyanates, polyols, amino acids, and sugars, and also represents at least one agrochemical active ingredient and optionally auxiliaries and fillers.

### BACKGROUND OF THE INVENTION

The present invention pertains to granulated solids that contain alkylpolyglycosides in combination with polymers and an agrochemical active ingredient, as well as a process for producing such agents.

In the production of agrochemical agents, especially of pesticides, these are frequently granulated, although problems can arise with the solubility of these agents. Such problems arise especially when the pesticides are to be used and employed in combination with nonionic surfactants. Certain nonionic surfactants, the alkylpolyglycosides, are in principle particularly suitable auxiliaries for formulating pesticides, since they have excellent properties in terms of both their toxicology and their environmental acceptability. In addition, they are especially suitable to improve the spreading of the agents on the plant surface, but also the penetration of the active ingredients into the plants. However, especially at higher fractions of these alkylpolyglycosides in the agents, the problem arises that the solids produced in this way have a poor rate of dissolution in water. In addition, as a result of the production of aqueous pastes as a base for the later granulation, considerable quantities of energy must be used during the production of the agents.

The improvement of the solubility of pesticide-containing granulates is the subject of various patent applications, wherein reference is particularly made to WO 03/039249. The technical teaching of this document provides that mixtures of pesticides with a polymer that contains both hydrophilic and hydrophobic monomers must be mixed uniformly and converted to a dry end product. As suitable auxiliaries, among others, alkylpolyglycosides [are mentioned], without the document providing a specific exemplified description of such agents. In WO 98/33383, solids containing alkylpolyglycosides in mixtures with herbicides of the sulfonylurea type are disclosed. It can be seen from the examples that water is exclusively used as the granulating liquid, and is removed from the end products by drying.

Therefore the present invention is based on the goal of supplying agents with high alkylpolyglycosides contents, which contain agrochemical active ingredients and especially pesticides and nevertheless are highly water-soluble.

It was found that the combination of alkylpolyglycosides with selected polymers is able to achieve the aforementioned goal.

### BRIEF SUMMARY OF THE INVENTION

The object of the present invention is therefore solids containing at least (A) compounds of the general formula RO-[G]ₚ, in which R represents an alkyl and/or alkenyl radical with 4 to 22 carbon atoms, G represents a sugar radical with 5 or 6 carbon atoms, and p represents numbers from 1 to 10, and (B) 95 to 5 wt % of water-soluble, nonionic, homopolymeric and/or copolymeric compounds, wherein the monomers are selected from (I) compounds of the formula R¹R²C═CR³X, in which R¹, R², and R³ each independently represent a hydrogen atom or an aliphatic alkyl radical with 1 to 4 C atoms or an acryl radical possibly containing N or O atoms and X represents a group OR⁴, OCOH, OCOY, OCOR⁵, CONR⁶, CN, NR⁷₂, NH—CO—R⁸, wherein the radicals R⁴ to R⁸ independently represent a hydrogen atom or saturated or unsaturated, branched or unbranched aliphatic or aromatic organic radicals with 1 to 22 C atoms, and Y represents a cation, (II) unsaturated dicarboxylic acids, preferably maleic acid or aspartic acid and derivatives thereof, (III) isocyanates, (IV) polyols, (V) amino acids, and (VI) sugars, and also (C) represents at least one agrochemical active ingredient and optionally (D) auxiliaries and fillers. Preferably, granulated or extruded solids are used.

### DETAILED DESCRIPTION OF THE INVENTION

The solids in the sense of the present invention contain alkylpolyglycosides (abbreviation: APG) in quantities of up to 80 wt %. Preferably in quantities of 1 to 45 wt %, wherein it is preferred that the agents contain 5 to 25 and especially 5 to 15 wt % alkylpolyglycosides, based on the total agent. Alkyl- and alkenyl oligoglycosides represent inherently know nonionic surfactants that follow the formula RO-[G]ₚ, in which R represents an alkyl and/or alkenyl radical with 4 to 22 carbon atoms, G represents a sugar radical with 5 or 6 carbon atoms, and p represents numbers from 1 to 10. They can be obtained according to the relevant processes of preparative organic chemistry. The alkyl and/or alkenyl oligoglycosides can be derived from aldoses or ketoses with or 6 carbon atoms, preferably glucose. The preferred alkyl and/or alkenyloligoglycosides are thus alkyl and/or alkenyloligoglucosides. The subscript p in the above general formula indicates the degree or oligomerization (DP), i.e., the distribution of mono- and oligoglycosides, and represents an integer between 1 and 10. Whereas p in a given compound must always be an integer and here in particular can assume the values p=1 to 6, the value p for a certain alkyloligoglycoside is an analytically determined, computed value, which generally represents a fractional number.

Preferably, alkyl and/or alkenyloligoglycosides with a mean degree of oligomerization p of 1.1 to 3.0 are used. From the viewpoint of applications technology, such alkyl and/or alkenyl oligoglycosides are preferred, the degree of oligomerization of which is less than 2.0 and especially between 1.2 and 1.7, preferably between 1.2 and 1.4

The alkyl or alkenyl radical R can be derived from primary alcohols with 4 to 11, preferably 8 to 10 carbon atoms. Typical examples are butanol, capron alcohol, capryl alcohol, capric alcohol, and undecyl alcohol, as well as technical mixtures thereof, as are obtained for example during the hydrogenation of technical fatty acid methyl esters or in the course of the hydrogenation of aldehydes from Roelen's oxo synthesis. Preferred are alkyloligoglucosides with chain length C₈-C₁₀ (DP=1 to 3), which are obtained as first runnings in the distillative separation of technical C₈-C₁₈ coconut fatty alcohol and may be contaminated with a fraction of less than 6 wt % C₁₋₂ alcohol as well as alkyloligoglucosides on the basis of technical C₉₋₁₁ oxo alcohols (DP=1 to 3).

The alkyl or alkenyl R can also be derived from primary alcohols with 12 to 22, preferably 12 to 14 carbon atoms. Typical examples are lauryl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol, and technical mixtures thereof, which can be obtained as described above. Alkyloligoglucosides on the basis of hardened C₁₂₋₁₄ coconut alcohol with a DP of 1 to 3 are preferred.

The component B) in the agents in accordance with the invention is represented by water-soluble, nonionic or anionic, homopolymeric and/or copolymeric compounds, which can be prepared from a number of monomers (I-VI). In this process, all manufacturing methods known to the expert for polymerization can be used. It is essential that the polymers in the sense of the present invention be completely water-soluble at room temperature (21° C.). Preferred polymers have a water solubility of at least 50 g/L. In addition it may be advantageous to select polymers that are able to form stable films after the solvent has dried.

Particularly preferred, however, are homopolymers from the monomers I to VI. Here it has been found that homopolymers of acrylic acid or methacrylic acid are able to accomplish the goal of the present invention in an especially advantageous way, wherein these homopolymers generally should have a mean molecular weight in the range of 500 to 200,000, especially 500 to 25,000, preferably 1000 to 20,000 and particularly preferably 2000 to 20,000. The range from 2000 to 100,000 can also be advantageous. Once again, the homopolymers of acrylic acid with these molecular weights are especially preferred. Both nonionic monomers and anionic group-containing monomers in the sense of the present invention can be used. Salts of acrylic acid or methacrylic acid, especially their sodium salts, are particularly preferred.

Also preferred in the sense of the present invention is the use of compounds of formula I and here especially of copolymers of acrylic acid with maleic acid or maleic anhydride, which are sold under the brand Sokalan® by BASF, for example as Sokalan® CP. In the case of the copolymers of oleic and maleic acid, polymers are preferred, the mean molecular weight of which falls in the range between 1000 and 1000,000.

In addition, polymers on the basis of the other monomers II to VI can be used successfully in the sense of the present technical teaching. Both homopolymers and arbitrary copolymers from the monomeric building blocks I to VI may be used, insofar as the resulting polymers are water-soluble.

The agents in the sense of the present technical teaching contain the polymeric components (B) preferably in quantities between 0.3 and 45 and especially from 1.0 to 15 wt %, based on the total agent. It is also preferred to select agents in which the weight ratio between components (A) and (B) falls in the range of 10:1 to 1:10, preferably 4:1 to 1:1, and especially 2:1 to 1:1, wherein mixtures in a 1:1 ratio are particularly preferred.

An additional preferred embodiment pertains to agents containing a mixture of APG (A) and the polymer (B)—in each case based on dry weight—in a weight ratio of about 4:1, i.e., 80 wt % APG and 20 wt % polymer.

Polymers are not suitable which contain monomers with charged atoms, preferably cationic nitrogen atoms. Such monomers are concretely disclosed in the previously cited WO 03/039249. No protection is claimed for such polymers.

The agents of the present invention contain at least one agrochemical active ingredient, i.e., a fertilizer, pesticide, herbicide, fungicide, acaricide, or rodenticide. The use of pesticides and especially herbicides is preferred. Mixtures of different active ingredients are also possible. Both water-soluble and water-insoluble active ingredients may be used, wherein the use of water-soluble active ingredients may be preferred. Particularly suitable active ingredients are specifically disclosed in the above-cited WO 03/039249 on pages 10 to 16. The disclosure of this part of WO 03/039249 is also made part of the disclosure of the present application. The agents of the present invention contain preferably 1 to 95 wt % and especially 5 to 75 wt % of agrochemical active ingredients. Preferred are agents that contain compounds from the herbicides group as agrochemical active ingredients (C). It is particularly preferred in this connection that the agents are free from compounds of the sulfonylurea type in the sense of WO 98/33383.

In addition, the agents can optionally contain additional customary auxiliaries and additives, for example amorphous, microcrystalline celluloses, zeolites, bentonites, and organic or inorganic salts, for example sodium carbonate or sulfate, urea, or water glass.

The preparation of the agents in accordance with the invention takes place by mixing the components A) to D) and then drying in suitable apparatus. In WO 01/79414 of the applicant, such procedures are already described for polymer-containing mixtures, but they contain no agrochemical active ingredients. Suitable apparatus may be: fluidized layer, fluidized bed, spray tower, contact dryer such as that from the firms of Vomm, VRV or Ballestra, as well as flash dryers from the Chemithon company.

The solids in the sense of the present invention are preferably produced in that the component A) as an aqueous paste or solution is mixed with an aqueous solution of B) in the desired weight ratio —based on active substance —and the components C) and possibly D) and then dried in a fluidized bed, preferably at product temperatures between 50 and 85° C. The air temperature is preferably 20 to 50° C. above the product temperature.

In addition to the preparation by fluidized bed granulation, other manufacturing methods are also possible, such as spray drying or preferably extrusion. The preferred process for producing granulates, however, is fluidized bed granulation. This is defined as granulation under simultaneous drying, which preferably takes place batchwise or continuously. In this process the surfactants and polymers in accordance with the invention can be used, possibly in combination with other ingredients, both in the dried state and as an aqueous or paste preparation.

It is also possible to produce the agents in accordance with the invention by first granulating components (A) and (B) together and then treating this granulate with components (C) and possibly (D) for the final formulation, preferably likewise by granulation or extrusion.

Finally, the solids in the sense of the present technical teaching may also be produced in that the components (A) and (B) are mixed in respectively granulated form, preferably by fluidized bed granulation, with the components (C) and possibly (D), water is added, and this mixture if desired is then extruded into a granulate. The mixtures of the granulated preproducts and the other components can be used without further processing or preferably be processed into end products.

An additional object of the present invention pertains to the use of granulates in accordance with the above description for producing pesticides.

### EXAMPLES

Two mixtures of a C8-C10 alkyloligoglucoside with a DP of 1.6 with polyacrylic acid in weight ratios of 1:1 and 2.7:1 were produced and then granulated in a fluidized bed.

These granulates were reacted with atrazine and Cu(OH)₂ respectively to form pesticide formulations.

### Example 1

An aqueous C8-C10 alkylpolyglucoside paste (60 wt % APG, 40 wt % water) was mixed with an aqueous polyacrylic acid-sodium salt (45 wt % polymer, 55 wt % water, MW 4500) in a 1:1 weight ratio. The solution produced in this way was dried in a fluidized bed at an air temperature of 120° C. and a product temperature of 72° C. Flowable granulates with a weight content of 57% APG and 43% of the polyacrylic acid salt were obtained.

### Example 2

An aqueous C8-C10 alkylpolyglucoside paste (60 wt % APG, 40 wt % water) was mixed with an aqueous polyacrylic acid-sodium salt (45 wt % polymer, 55 wt % water, MW 4500) in a 2.7:1 weight ratio. The solution produced in this way was dried in a fluidized bed at an air temperature of 120° C. and a product temperature of 74° C. Flowable granulates with a weight content of 80% APG and 20% polyacrylic acid salt were obtained.

### Example 3

An extrudate was produced from a granulated premixture of a 1:1 mixture of APG and polyarylic acid (MW 4500) with atrazine in the presence of sodium sulfate and naphthalene sulfonate. The end product contained 80 wt % atrazine, 10 wt % of the premix of APG and polyacrylic aid, 7 wt % sodium sulfate, and 3 wt % naphthalenesulfonate.

1: A solid composition comprising:
(a) a compound corresponding to formula I:
RO-[G]ₚ (I)
wherein R represents an alkyl and/or alkenyl radical with 4 to 22 carbon atoms, G represents a sugar radical with 5 or 6 carbon atoms, and p represents a number from 1 to 10;
(b) a water-soluble, nonionic or anionic, homo- and/or co-polymeric compound, whose monomers are selected from the group consisting of: (i) a compound corresponding to formula (II):
R¹R²C═CR³X (II)
wherein R¹, R², and R³, each independently of one another, represent a hydrogen atom or an aliphatic alkyl radical having from 1 to about 4 carbon atoms or an acryl radical containing a nitrogen or oxygen atom, and X represents a group selected from the group consisting of OR⁴, OCOH, OCOY, OCOR⁵, CONR⁶, CN, NR⁷₂, NH—CO—R⁸, wherein R⁴ to R⁸, each independently of one another, represent a hydrogen atom or a saturated or unsaturated, branched or unbranched aliphatic or aromatic organic radical having from 1 to about 22 C atoms, and Y represents a cation; (ii) an unsaturated dicarboxylic acid or derivative thereof; (iii) an isocyanate; (iv) a polyol; (v) an amino acid; (vi) a sugar; and mixtures thereof;
(c) at least one agrochemical active ingredient;
(d) optionally, an auxiliary; and
(e) optionally, a filler.

2: The composition of claim 1 wherein (a) is present in the composition in an amount of from about 1 to about 45% by weight, based on the weight of the composition.

3: The composition of claim 1 wherein (b) is present in the composition in an amount of from about 0.3 to about 45% by weight, based on the weight of the composition.

4: The composition of claim 1 wherein (c) is present in the composition in an amount of from about 1 to about 95% by weight, based on the weight of the composition.

5: The composition of claim 1 wherein (d) is present in the composition in an amount of from about 1 to about 85% by weight, based on the weight of the composition.

6: The composition of claim 1 wherein (a) and (b) are present in the composition in a ratio by weight of from about 10:1 to about 1:10.

7: The composition of claim 1 wherein (b) is selected from the group consisting of polyacrylic acid, polymethacrylic acid, a polyacrylic acid salt, a polymethacrylic acid salt, and mixtures thereof.

8: The composition of claim 1 wherein (b) is a copolymer of acrylic or methacrylic acid with maleic acid or maleic anhydride, and has a mean molecular weight of from about 1000 to about 10,000.

9: The composition of claim 1 wherein (c) is selected from the group consisting of a fertilizer, a pesticide, an herbicide, a fungicide, an acaricide, a rodenticide, and mixtures thereof.

10: The composition of claim 1 wherein (c) is an herbicide.

11: The composition of claim 1 wherein (c) is a sulfonylurea.
